(19) United States
(12) Patent Application Publication
(10) Pub. No.: US 2004/0003783 A1
(43) Pub. Date: Jan. 8, 2004

(54) Internal combustion engine

(76) Inventors: Oleg Naljotov, Brooklyn, NY (US); Valentin Potienko, Brooklyn, NY (US)

Correspondence Address: OLEG NALJOTOV, 1975 84 Str. AP# B2, BROOKLYN, NY, 11214, US

(21) Appl. No.: 10/155,278

(22) Filed: Jul. 2, 2002

(51) Int. Cl. F02B 75/02

(52) U.S. Cl. 123/65 S

(57) ABSTRACT

The invention is related to engine construction; more specifically it is within the category of two stroke internal combustion engines.

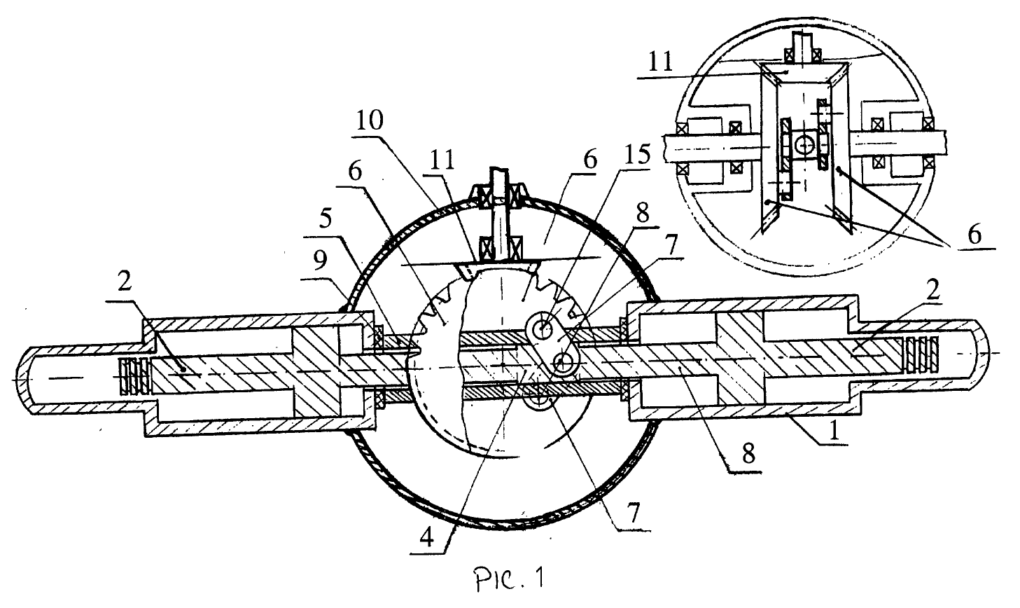

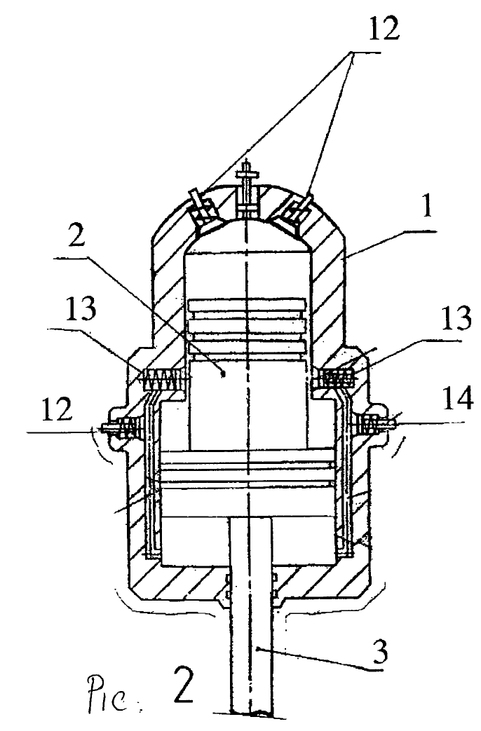

The engine has: body (10), two cylinders (1), two stepped pistons (2), injection valves (14), transfer (13) and ejection valves.

The piston (2) is rigidly fixed to the piston rod (3) and to the slider (4), which is attached by connecting rods (7) and collar pins (8) and (15) to the driving pinions (6). The pinions are brought to an opposite rotating motion and are interconnected through a conic pinion gear (11), which is brought out to the transmission.

The advantage of this engine is in the use of the second halt of the cycle, which in existing designs produces only additional resistance. The efficiency of this design is 80±5%.

If the length of the connecting rod exceeds the radius of rotation then the piston throw will be 2R or D, where R is the radius of the crank, D is the diameter of cylinder. If the length of the connecting rod equals the radius of rotation then the piston throw is 4R or 2D as shown in the accompanying drawings—for the low speed engines. This provides 100% compression, and a high power source. Because of the high temperature working regime the design is environmentally clean. The Carbon Monoxide (CO) is burned up.

Resume: engine is environmentally clean, has high efficiency, and has a size and weigh.

### DESCRIPTION OF THE INVENTION “INTERNAL COMBUSTION ENGINE”

The invention is related to engine construction; more specifically it is within the category of two stroke internal combustion engines.

The engine has: body (10), two cylinders (1), two stepped pistons (2), injection valves (14), transfer (13) and ejection valves.

The piston (2) is rigidly fixed to the piston rod (3) and to the slider (4), which is attached by connecting rods (7) and collar pins (8) and (15) to the driving pinions (6). The pinions are brought to an opposite rotating motion and are interconnected through a conic pinion gear (11), which is brought out to the transmission.

The advantage of this engine is in the use of the second halt of the cycle, which in existing designs produces only additional resistance. The efficiency of this design is 80±5%.

If the length of the connecting rod exceeds the radius of rotation then the piston throw will be 2R or D, where R is the radius of the crank, D is the diameter of cylinder. If the length of the connecting rod equals the radius of rotation then the piston throw is 4R or 2D as shown in the accompanying drawings—for the low speed engines. This provides 100% compression, and a high power source. Because of the high temperature working regime the design is environmentally clean. The Carbon Monoxide (CO) is burned up.

Resume: engine is environmentally clean, has high efficiency, and has a small size and weigh.

1. What I claim as my invention “Internal Combustion Engine”.
